(19) United States
(12) Patent Application Publication
(10) Pub. No.: US 2022/0069280 A1
(43) Pub. Date: Mar. 3, 2022

(54) COMPOSITE ELECTRODE MATERIALS AND METHODS OF MAKING THE SAME

(71) Applicant: GM GLOBAL TECHNOLOGY OPERATIONS LLC, Detroit, MI (US)

(72) Inventors: Xingcheng Xiao, Troy, MI (US); Mark W. Verbrugge, Troy, MI (US)

(73) Assignee: GM GLOBAL TECHNOLOGY OPERATIONS LLC, Detroit, MI (US)

(21) Appl. No.: 17/005,559

(22) Filed: Aug. 28, 2020

(51) Int. Cl. H01M 4/133; H01M 4/134; H01M 4/38; H01M 4/1395; H01M 4/04; H01M 4/36; H01M 4/60; H01M 10/0525; H01M 4/1393

(52) U.S. Cl. CPC H01M 4/133; H01M 4/134; H01M 4/386; H01M 4/1395; H01M 4/1393; H01M 4/366; H01M 4/602; H01M 4/0428; H01M 10/0525; H01M 4/0471

(57) ABSTRACT

A composite electrode material may include a carbon-based matrix component and a silicon-based particulate component embedded in the carbon-based matrix component. The silicon-based particulate component may include a plurality of core-shell structures, with each core-shell structure including: a silicon core, an intermetallic layer overlying the core, and a graphitic shell surrounding the silicon core and the intermetallic layer. In a method of making the composite electrode material, a metal catalyst layer may be deposited on a plurality of silicon particles to form a plurality of precursor structures in particle form. The precursor structures may be dispersed in organic polymeric material to form a precursor electrode material, which may be heated in an inert environment to pyrolyze the organic polymeric material and transform the precursor electrode material into a composite electrode material.

The present invention relates to secondary lithium-ion batteries.

A battery is a device that converts chemical energy into electrical energy via electrochemical reduction-oxidation (redox) reactions. In secondary or rechargeable batteries, these electrochemical reactions are reversible, which allows the batteries to undergo multiple charging and discharging cycles.

Secondary lithium-ion batteries generally comprise one or more electrochemical cells that include a negative electrode, a positive electrode, and an electrolyte that provides a medium for the conduction of lithium ions through the electrochemical cell between the negative and positive electrodes. During charging, lithium ions are released from the positive electrode, transported through the electrolyte, and inserted into the material of the negative electrode for storage. During discharge, lithium ions are released or extracted from the negative electrode material and transferred back to the positive electrode. The amount of charge a lithium-ion battery can hold thus depends on the lithium ion storage capacity of the negative electrode material. In addition, the usable cycle life of such batteries is dependent on the number of times the negative electrode material can effectively take up and release lithium ions without experiencing significant mechanical degradation and/or capacity loss.

Carbon-based materials (e.g., graphite) are oftentimes used as electrochemically active negative electrode materials in lithium-ion batteries due to their effective ability to store lithium ions in between layers of graphite sheets via a mechanism known as intercalation. Such carbon-based materials experience low-volume expansion and contraction when accepting (intercalation) and releasing (deintercalation) lithium ions, which provides such materials with suitable mechanical stability for long-term use as negative electrode materials. Graphitic carbon-based negative electrode materials, however, exhibit a relatively low theoretical specific capacity of about 372 mAh/g. In addition, during initial battery cycling, lithium ions may be consumed and immobilized as a result of the formation of a solid electrolyte interface (SEI) along the surface of carbon-based negative electrode material, which may lead irreversible capacity loss and also may hinder subsequent lithium ion intercalation processes.

Silicon has been identified as a desirable electrochemically active negative electrode material for secondary lithium-ion batteries due to its high theoretical specific capacity (e.g., 4200 mAh/g). Silicon-based negative electrode materials store lithium ions in their structural framework by formation of LiSix alloy compounds. However, during the lithium ion insertion and removal processes, the silicon-based negative electrode materials expand and contract in volume significantly, which can lead to mechanical stresses and promote degradation of the negative electrode materials over time.

### SUMMARY

A composite electrode material may comprise a carbon-based matrix component and a silicon-based particulate component embedded in the carbon-based matrix component. The silicon-based particulate component may include a plurality of core-shell structures. Each of the core-shell structures may include a silicon core, an intermetallic layer overlying the core, and a graphitic shell surrounding the silicon core and the intermetallic layer.

The silicon-based particulate component may account for, by weight, 10% to 90% of the composite electrode material.

The plurality of core-shell structures may be homogenously distributed throughout the carbon-based matrix component.

The silicon core may comprise, by weight, greater than 99% silicon (Si).

The intermetallic layer may comprise a metal silicide. The metal silicide may comprise at least one metal selected from the group consisting of copper, nickel, iron, or cobalt.

In each core-shell structure, the intermetallic layer may be disposed between the silicon core and the graphitic shell.

The graphitic shell may comprise crystalline graphite.

The carbon-based matrix component may comprise an amorphous hard carbon.

The carbon-based matrix component may not include discrete particles or regions of crystalline graphite.

In a method of making a composite electrode material, a plurality of silicon particles may be provided, with each silicon particle having a surface. A metal catalyst layer may be deposited on the surface of each silicon particle to form a plurality of precursor structures. The precursor structures may be dispersed in an organic polymeric material to form a precursor electrode material. The precursor electrode material may be heated in an inert environment: (i) to convert the organic polymeric material into a carbon-based material, (ii) to convert at least a portion of the metal catalyst layer on the surface of each silicon particle into a metal silicide, and (iii) to form a graphitic shell around each silicon particle.

The plurality of silicon particles may exhibit a mean particle diameter in a range of 10 nanometers to 40 micrometers.

The metal catalyst layer may be deposited on the surface of each silicon particle using a wet chemical deposition technique, a chemical vapor deposition technique, or a high energy ball milling technique.

The metal catalyst layer may comprise at least one metal selected from the group consisting of copper, nickel, iron, or cobalt.

The metal catalyst layer may have a thickness in a range of 2 nanometers to 200 nanometers.

The organic polymeric material may comprise polyimide or polyacrylonitrile.

The precursor electrode material may be heated in the inert environment at a temperature in a range of 400° C. to 900° C. to pyrolyze the organic polymeric material.

During heating of the precursor electrode material in the inert environment, the metal catalyst layer on the surface of each silicon particle may promote formation of the graphitic shell around each silicon particle.

During heating of the precursor electrode material in the inert environment, the metal catalyst layer on the surface of each silicon particle may physically isolate each silicon particle from the organic polymeric material and prevent formation of silicon carbide (SiC).

In a method of making a composite negative electrode material for a lithium-ion battery, a plurality of silicon particles may be provided, with each silicon particle having a surface. A metal catalyst layer may be deposited on the surface of each silicon particle to form a plurality of precursor structures. The precursor structures may be dispersed in an organic polymeric material to form a precursor electrode material. The precursor electrode material may be heated in an inert environment to pyrolyze the organic polymeric material and transform the precursor electrode material into a composite electrode material that includes a carbon-based matrix component and a silicon-based particulate component embedded in the carbon-based matrix component. The silicon-based particulate component may include a plurality of core-shell structures. Each core-shell structure may include a silicon core, an intermetallic layer overlying the core, and a graphitic shell surrounding the silicon core and the intermetallic layer.

The intermetallic layer may comprise a metal silicide. The metal silicide may comprise at least one metal selected from the group consisting of copper, nickel, iron, or cobalt.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

Illustrative embodiments will hereinafter be described in conjunction with the appended drawings, wherein like designations denote like elements, and wherein:

FIG. 1 is a schematic side cross-sectional view of an electrochemical cell for a secondary lithium ion battery including a negative electrode, a positive electrode, and a nonaqueous electrolyte in ionic contact with the negative and positive electrodes;

FIG. 2 is an enlarged cross-sectional view of a portion of the negative electrode of FIG. 1 depicting a portion of a negative current collector and a composite negative electrode material layer overlying the negative current collector, the composite negative electrode material layer including a carbon-based matrix component and a silicon-based particulate component embedded in the carbon-based matrix component;

FIG. 3 is an enlarged cross-sectional view of a portion of the silicon-based particulate component of the composite negative electrode material layer of FIG. 2, in accordance with one embodiment of the present disclosure; and

FIG. 4 is an enlarged cross-sectional view of a portion of the silicon-based particulate component of the composite negative electrode material layer of FIG. 2, in accordance with another embodiment of the present disclosure.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

The presently disclosed composite electrode material includes a carbon-based matrix component and a silicon-based particulate component embedded or dispersed in the carbon-based matrix component. The silicon-based particulate component is made-up of a number of discrete particles or regions dispersed throughout the carbon-based matrix component, with each discrete region exhibiting a core-shell structure that includes a silicon core, an intermetallic layer overlying the silicon core, and a graphitic shell surrounding the silicon core and the intermetallic layer. The silicon-based particulate component provides the composite electrode material with a relatively high specific capacity, as compared to electrode materials that do not include silicon, as well as exceptional mechanical robustness, improved capacity retention, and an increased cycle life, as compared to electrode materials that include silicon particles, but do not include silicon particles having an intermetallic layer formed thereon.

Prior to formation of the presently disclosed composite electrode material, a number of silicon particles are provided and a metal catalyst layer (i.e., a layer of Cu, Ni, Fe, or Co, and/or an alloy thereof) is deposited on a surface of each of the silicon particles to form a number of precursor structures. Then, the precursor structures are dispersed in an organic polymeric material to form a precursor electrode material, which is heat-treated to pyrolyze the organic polymeric material and transform the precursor electrode material into the composite electrode material.

Without intending to be bound by theory, it is believed that, during the heat-treatment process, the metal catalyst layer promotes the formation of a graphitic carbon shell around each of the silicon particles, instead of the formation of non-graphitic carbon, which would otherwise form adjacent and around each of the silicon particles if the metal catalyst layer was not present. The graphitic carbon shell formed around each of the silicon particles may exhibit an improved ability to absorb the volume expansion experienced by the silicon particles during lithiation, as compared to non-graphitic carbon. In addition, during the heat-treatment process, at least a portion of each of the metal catalyst layers may react with its associated underlying silicon particle to produce a metal silicide, which may help improve the electric and ionic conductivity of the composite electrode material. In addition, formation of the metal catalyst layers on the silicon particles also may help prevent undesirable chemical reactions from occurring between the silicon particles and the surrounding carbon-based matrix component, which might otherwise lead to the undesirable formation of silicon carbide (SiC). These and other benefits will be readily appreciated by those of ordinary skill in the art in view of the following disclosure.

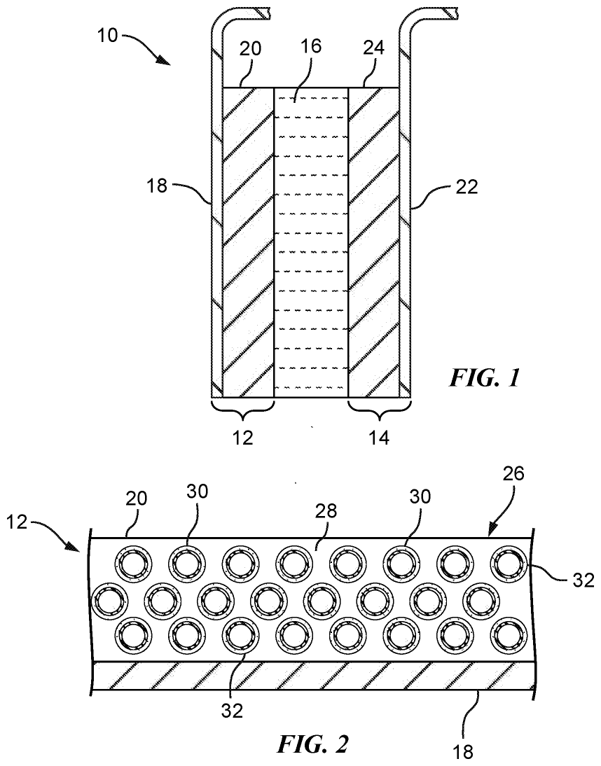

FIG. 1 illustrates a schematic cross-sectional view of an electrochemical cell 10 of a secondary lithium metal battery (not shown). The electrochemical cell 10 comprises a negative electrode 12, a positive electrode 14, and a nonaqueous electrolyte 16 in ionic contact with the negative electrode 12 and the positive electrode 14. The negative electrode 12 includes a negative current collector 18 and an electrochemically active negative electrode material layer 20 overlying the negative current collector 18. The positive electrode 14 includes a positive current collector 22 and an electrochemically active positive electrode material layer 24 overlying the positive current collector 22. The positive and negative electrodes 12, 14 are spaced apart from one another and, in assembly, may be physically separated from one another by a porous separator (not shown). In assembly, the negative electrode 12 may be electrically coupled to the positive electrode 14 via an external circuit (not shown) so that electrons can flow between the negative and positive electrodes 12, 14 while lithium ions simultaneously travel through the nonaqueous electrolyte 16 between the negative electrode material layer 20 and the opposing positive electrode material layer 24 during cycling of the electrochemical cell 10.

Referring now to FIG. 2, the negative electrode material layer 20 exhibits a composite structure 26 that includes a carbon-based matrix component 28 and a silicon-based particulate component 30 embedded or dispersed in the carbon-based matrix component 28. The matrix component 28 and the particulate component 30 exist as separate and discrete phases within the composite structure 26 of the negative electrode material layer 20 and have different chemical compositions and different chemical and mechanical properties. As such, the matrix component 28 and the particulate component 30 each contribute a separate set of desirable attributes or characteristics to the negative electrode material layer 20, which, in combination, can improve the overall performance of the electrochemical cell 10. For example, the combination of the matrix component 28 and the particulate component 30 provides the negative electrode material layer 20 with improved mechanical integrity and robustness, and also provides the electrochemical cell 10 with increased energy density and cycle stability, as compared to electrochemical cells that do not include a negative electrode material layer having the presently disclosed composite structure 26.

The carbon-based matrix component 28 may account for, by weight, about 5-40% of the overall negative electrode material layer 20 and the silicon-based particulate component 30 may account for, by weight, about 60-95% of the overall negative electrode material layer 20. In some embodiments, the matrix component 28 may account for, by weight, about 10-30% of the negative electrode material layer 20 and the particulate component 30 may account for about 70-90% of the negative electrode material layer 20. As used herein, the phrase “of the overall negative electrode material layer 20” means the same thing as “of the overall composite structure 26.”

The carbon-based matrix component 28 may include a continuous monolithic three-dimensional network in which the particulate component 30 is embedded or dispersed. The term “monolithic” refers to a solid, three-dimensional structure that is not particulate in nature. The carbon-based matrix component 28 may be electrically conductive and electrochemically active. For example, the carbon-based matrix component 28 may be capable of undergoing the reversible insertion or intercalation of lithium ions.

The carbon-based matrix component 28 is a carbon-based material and may be derived from the pyrolysis of an organic polymeric material. The terms “carbon-based material” and “carbon material,” as used herein, refer to materials that primarily consist of carbon, meaning that carbon is the single largest constituent of the material, based upon the overall weight of the material. This may include materials that include, by weight, greater than 50% carbon (C), as well as those that include, by weight, less than 50% carbon (C), so long as carbon (C) is the single largest constituent. In some embodiments, the carbon-based matrix component 28 may comprise, by weight, greater than 75% carbon, preferably greater than 90% carbon, and more preferably greater than 99% carbon. The carbon-based matrix component 28 may comprise one or more non-metal elements (e.g., oxygen, hydrogen, and/or nitrogen), which may be present in the carbon-based matrix component 28 as residual by-products of pyrolysis of the organic polymeric material. Such non-metal elements may be present in the carbon-based matrix component 28 in relatively small amounts, for example, in amounts, by weight, less than 25%, preferably less than 10%, and more preferably less than 1% of the overall carbon-based matrix component 28.

The carbon-based matrix component 28 may comprise an amorphous hard carbon. The term “hard carbon” refers to a non-graphitizing carbon material, meaning that, at elevated temperatures (e.g., temperatures greater than 1500° C.) the carbon material will remain substantially amorphous and cannot be converted into crystalline graphite via heat treatment. A “soft” carbon, on the other hand, can be converted into polycrystalline graphite when heated at such temperatures. In some embodiments, prior to lithiation, the carbon-based matrix component 28 may consist essentially of amorphous hard carbon and thus may be substantially free of other forms (i.e., allotropes) of carbon. Specific allotropes of carbon that are preferably excluded from the carbon-based matrix component 28 include graphite. In some embodiments, the carbon-based matrix component 28 may comprise, by weight, greater than 75% amorphous hard carbon.

In some embodiments, the carbon-based matrix component 28 may be porous, for example, and may exhibit a porosity in a range of 1-70%, preferably in a range of 5-50%, and more preferably in a range of 10-40%.

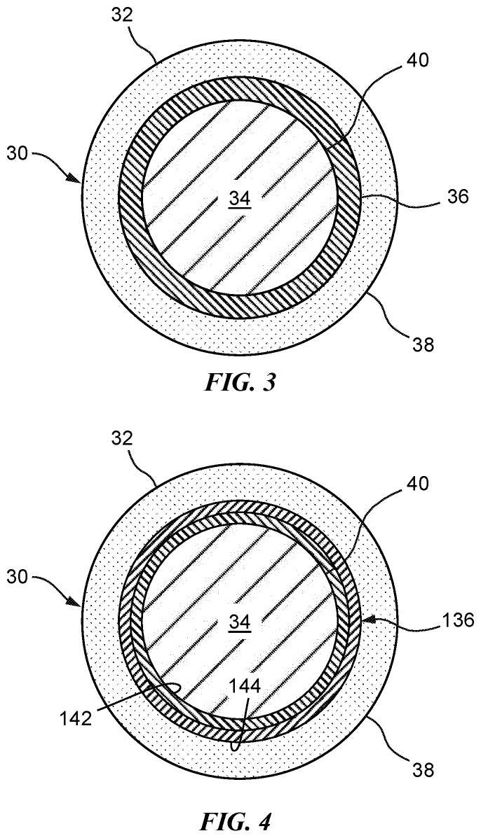

The silicon-based particulate component 30 is the major component of the negative electrode material layer 20 and includes a number of discrete particles or three-dimensional regions 32 within the composite structure 26 of the negative electrode material layer 20 that exhibit different chemical and/or mechanical properties than that of the surrounding carbon-based matrix component 28. As shown in FIG. 3, each of the discrete particles or regions 32 that make-up the silicon-based particulate component 30 of the negative electrode material layer 20 may exhibit a core-shell structure that includes a silicon core 34, an intermetallic layer 36 overlying the core 34, and a graphitic shell 38 surrounding the core 34. The silicon-based particulate component 30 of the negative electrode material layer 20 will be further described herein with respect to one discrete particle or region 32 thereof; however, it is to be understood that such description is equally applicable to all discrete particles or regions 32 of the composite structure 26 that make-up the silicon-based particulate component 30 of the negative electrode material layer 20.

The silicon core 34 is electrochemically active and is capable of storing lithium ions in its structural framework during charging of the electrochemical cell 10 and is likewise capable of releasing lithium ions therefrom during discharge of the electrochemical cell 10. The silicon core 34 is in indirect physical, electric, and ionic contact with the carbon-based matrix component 28 of the negative electrode material layer 20 via the intermetallic layer 36 and the graphitic shell 38. The silicon core 34 may be amorphous and/or crystalline and may comprise, by weight, prior to lithiation, greater than 90%, preferably greater than 95%, and more preferably greater than 99% silicon.

The intermetallic layer 36 overlies a surface 40 of the silicon core 34 and physically isolates the silicon core 34 from the graphitic shell 38 and from the surrounding carbon-based matrix component 28. In some embodiments, the silicon core 34 may be entirely encapsulated by the intermetallic layer 36. Without intending to be bound by theory, it is believed that the intermetallic layer 36 may help maintain the mechanical integrity of the silicon core 34 during repeated lithiation and delithiation cycles and also may help prevent formation of silicon carbide (SiC) within the regions 32, which may help maintain the electric and ionic conductivity of the negative electrode material layer 20.

The intermetallic layer 36 is formulated to exhibit good electric and ionic conductivity and may comprise a metal, a metal alloy, and/or a metal silicide. For example, the intermetallic layer 36 may comprise copper (Cu), nickel (Ni), iron (Fe), or cobalt (Co), and/or the intermetallic layer 36 may comprise an alloy of Cu, Ni, Fe, and/or Co. Additionally, or alternatively, the intermetallic layer 36 may comprise a metal silicide having the formula MeSix, where Me═Cu, Ni, Fe, and/or Co. In some embodiments, the intermetallic layer 36 may comprise at least one metal silicide in an amount, by weight, greater than 40%, preferably greater than 60%, and more preferably greater than 80% of the overall intermetallic layer 36. In some embodiments, the intermetallic layer 36 may consist essentially of the at least one metal silicide. In other embodiments, as best shown in FIG. 4, an intermetallic layer 136 may be formed on the surface 40 of the silicon core 34 that includes an inner metal silicide layer 142 and an outer metal layer 144. In such case, the inner metal silicide layer 142 may comprise or consist essentially of the at least one metal silicide and the outer metal layer 144 may comprise or consist essentially of Cu, Ni, Fe, and/or Co and/or an alloy of Cu, Ni, Fe, and/or Co.

The intermetallic layer 36, 136 may have a thickness in a range of 2 nanometers to 200 nanometers.

The graphitic shell 38 surrounds the silicon core 34 and the intermetallic layer 36, 136 and physically isolates the silicon core 34 and the intermetallic layer 36, 136 from the surrounding carbon-based matrix component 28. The graphitic shell 38 may comprise a graphitic material. A “graphitic material” refers to a material that has a graphitic surface with a hexagonal arrangement of carbon atoms, and may include any material that has a graphitic surface, regardless of the physical, chemical, or structural properties of such material. Examples of graphitic materials include crystalline graphite and highly ordered pyrolytic graphite (HOPG).

The graphitic shell 38 may have a thickness in a range of one nanometer to 5 micrometers and may have a porosity in a range of 0.1% to 50%.

The negative electrode material layer 20 may be formed by a method that includes one or more of the following steps: (a) providing a plurality of silicon particles, (b) depositing a metal catalyst layer on a surface of each of the silicon particles to form a number of precursor structures in particle form, (c) dispersing the precursor structures in an organic polymeric material to form a precursor electrode material, (d) heating the precursor electrode material in an inert environment to pyrolyze the organic polymeric material and transform the precursor electrode material into a composite electrode material. The silicon particles provided in step (a) may exhibit a mean particle diameter in a range of 10 nanometers to 40 micrometers and may comprise, by weight, greater than 90%, preferably greater than 95%, and more preferably greater than 99% silicon.

The metal catalyst layer deposited on the surface of each of the silicon particles in step (b) may comprise a metal or a metal alloy. For example, the metal catalyst layer may comprise Cu, Ni, Fe, and/or Co, and/or the catalyst layer may comprise an alloy of Cu, Ni, Fe, and/or Co. The metal catalyst layer may be deposited on the surface of each of the silicon particles using a wet chemical deposition process, a physical vapor deposition process, a high energy ball milling process, or any other method that allows for the formation of a thin continuous layer of a metal or a metal alloy on the surface of each of the silicon particles. The metal catalyst layer deposited on the surface of each of the silicon particles may exhibit a thickness in a range of 2 nanometers to 200 nanometers.

In embodiments where a wet chemical deposition process is employed, an electroless deposition or an electroplating technique may be used. An electroless deposition technique may be employed to form a thin continuous layer of a metal or a metal alloy on the surface of each of the silicon particles, for example, by immersing the silicon particles in a solution containing a salt of the metal to be deposited on the silicon particles, and then adding a reducing agent (e.g., formaldehyde) thereto. The solution employed in the electroless deposition process also may include a complexant, a buffer, an exaltant, and/or a stabilizer. An electroplating technique may be employed to form a thin continuous layer of a metal or a metal alloy on the surface of each of the silicon particles, for example, by immersing the silicon particles in an electrolyte solution containing a salt of the metal to be deposited on the silicon particles, and then applying a direct electric current to the silicon particles so that the metal ions in the electrolyte solution are reduced to the zero valence state on the surface of the silicon particles. Examples of physical vapor deposition processes that may be used to deposit a metal catalyst layer on the surface of each of the silicon particles include cathodic arc deposition, electron-beam physical vapor deposition, evaporative deposition, pulsed laser deposition, sputter deposition, and pulsed electron deposition. In embodiments where a high energy ball milling process is employed, the silicon particles may be combined with nanometer-sized particles of Cu, Ni, Fe, and/or Co in the ball milling machine.

In step (c), the precursor structures formed in step (b) are dispersed in an organic polymeric material to form a precursor electrode material. The precursor structures may be dispersed in the organic polymeric material for example, by mixing the precursor structures with the organic polymeric material. The organic polymeric material may comprise an organic polymer or a combination of organic polymers. Organic polymers that may be included in the organic polymeric material of the precursor electrode material include polyimide and/or polyacrylonitrile. In some embodiments, the organic polymeric material also may include a solvent. In such case, the solvent may account for, by weight, 10-90% of the organic polymeric material. The precursor structures may account for, by weight, 0.01-20% of the overall precursor electrode material, and the organic polymeric material may account for, by weight, 0.01-20% of the overall precursor electrode material.

Prior to step (d), the precursor electrode material may be deposited on a surface of a substrate in the form of a continuous thin film. In some embodiments, the substrate may comprise a metallic foil or a metallic mesh. For example, the substrate may comprise a metallic foil or a metallic mesh having the same chemical composition as that of the negative current collector 18. In such case, the negative electrode material layer 20 may be formed on and bonded to the negative current collector 18 during pyrolysis of the organic polymeric material in step (d). In other embodiments, the substrate may comprise a template made of an inert material that will not react with the precursor electrode material and/or interfere with pyrolysis of the organic polymeric material during step (d). In such case, after completion of step (d), the composite electrode material may be removed from the template and bonded to the negative current collector 18 to form the negative electrode 12 of the electrochemical cell 10.

In step (d), the precursor electrode material may be heated in an inert oxygen-free environment (e.g., in argon, nitrogen, and/or hydrogen) and/or in a sub-atmospheric pressure environment at a temperature and for a duration sufficient to pyrolyze the organic polymeric material and transform the precursor electrode material into the composite structure 26 of the negative electrode material layer 20. For example, the precursor electrode material may be heated in an inert environment and/or in a sub-atmospheric pressure environment at a temperature in a range of greater than or equal to 400° C. and less than or equal to 900° C. to pyrolyze the organic polymeric material. Without intending to be bound by theory, it is believed that the presence of the metal catalyst layer on the surface of the silicon particles may lower the temperature at which the organic polymeric material can be heated to achieve complete pyrolysis thereof. For example, in some embodiments, pyrolysis of the organic polymeric material may be performed at temperatures greater than 600° C. and less than 800° C. More specifically, in some embodiments, pyrolysis of the organic polymeric material may be performed at temperatures greater than 700° C. and less than or equal to 750° C.

During pyrolysis of the organic polymeric material in step (d), the organic polymeric material thermally decomposes, carbon-heteroatom bonds are broken, volatile organic compounds and hydrocarbon radicals are released, and new carbon-carbon bonds are formed, thereby transforming the organic polymeric material into a solid carbon-based material. Some of the organic polymeric material located adjacent to and/or in physical contact with the metal catalyst layer on the surface of the silicon particles will be transformed into a graphitic carbon-based material (i.e., the graphitic shells 38). On the other hand, the remainder of the organic polymeric material that is not in physical contact with nor adjacent the metal catalyst layer will be transformed into a continuous phase of a non-graphitic carbon-based material (i.e., the carbon-based matrix component 28). Without intending to be bound by theory, it is believed that the presence of the metal catalyst layer on the surface of the silicon particles may help promote transformation of the portion of the organic polymeric material that is in physical contact therewith or in close proximity thereto into a graphitic carbon-based material, instead of a non-graphitic carbon-based material. Portions of the organic polymeric material that are not located in sufficiently close proximity to the metal catalyst layers on the surfaces of the silicon particles will be transformed into non-graphitic carbon-based materials, instead of graphitic carbon-based materials, during step (d).

Without intending to be bound by theory, it is believed that the presence of the metal catalyst layer on the surface of the silicon particles may help avoid chemical reactions between the organic polymeric material and the silicon particles during pyrolysis of the organic polymeric material in step (d). More specifically, it is believed that the presence of the metal catalyst layer on the surface of the silicon particles may inhibit or prevent the undesirable formation of silicon carbide (SiC) within the negative electrode material layer 20. It is believed that the formation of SiC may impede the flow of electrons and lithium ions within the negative electrode material layer 20. Therefore, by inhibiting or preventing the formation of SiC within the negative electrode material layer 20, the metal catalyst layer on the surface of the silicon particles may allow for the formation of a negative electrode material layer 20 having improved electric and ionic conductivity, as compared to composite negative electrode materials that are formed without the use of a metal catalyst layer.

Heating of the precursor electrode material in step (d) also may cause at least a portion of the metal (i.e., Cu, Ni, Fe, and/or Co) in the metal catalyst layer to react with silicon in the underlying silicon particle to form an intermetallic metal silicide, which may be represented by the chemical formula MeSix, where Me═Cu, Ni, Fe, and/or Co. The metal catalyst layer may be partially or entirely transformed into an intermetallic metal silicide during step (d). The proportion of the metal in the metal catalyst layer that reacts with silicon in the underlying silicon particle to form a metal silicide may depend, for example, on the thickness of the metal catalyst layer and/or on the duration of the pyrolysis process.

The nonaqueous electrolyte 16 may comprise any material that is capable of effectively conducting lithium ions between the negative and positive electrodes 12, 14. For example, the nonaqueous electrolyte 16 may comprise a liquid electrolyte. In such case, the electrolyte 16 may comprise a solution including a lithium salt dissolved or ionized in a nonaqueous, aprotic organic solvent or a mixture of nonaqueous, aprotic organic solvents. Lithium salts that may be used to make the electrolyte 16 include LiClO₄, LiAlCl₄, LiI, LiBr, LiSCN, LiBF₄, LiB(C₆H₅)₄, LiAsF₆, LiCF₃SO₃, LiN(CF₃SO₂)₂, LiPF₆, and mixtures thereof. The nonaqueous, aprotic organic solvent in which the lithium salt is dissolved may be a cyclic carbonate (i.e., ethylene carbonate, propylene carbonate), an acyclic carbonate (i.e., dimethyl carbonate, diethyl carbonate, ethylmethylcarbonate), an aliphatic carboxylic ester (i.e., methyl formate, methyl acetate, methyl propionate), a γ-lactone (i.e., γ-butyrolactone, γ-valerolactone), an acyclic ether (i.e., 1,2-dimethoxyethane, 1,2-diethoxyethane, ethoxymethoxyethane), a cyclic ether (i.e., tetrahydrofuran, 2-methyltetrahydrofuran), or a mixture thereof. As another example, the nonaqueous electrolyte 16 may comprise a gel or plasticized polymer electrolyte. In such case, the electrolyte 16 may comprise a polymer host material soaked with a liquid electrolyte solution. Examples of polymer host materials include poly(vinylidene) fluoride (PVdF), poly(acrylonitrile) (PAN), poly(methyl methacrylate) (PMMA), poly(ethylene oxide) (PEO), polyacrylates, and poly(vinylidene fluoride-hexafluoropropylene) (PVdF-HFP).

When present, the porous separator disposed between the negative and positive electrodes 12, 14 may comprise any material that can physically separate and electrically insulate the electrodes 12, 14 from one another while permitting the free flow of lithium ions therebetween. For example, the porous separator may comprise non-woven materials or microporous polymeric materials. In particular, the porous separator may comprise a single polyolefin or a combination of polyolefins, such as polyethylene (PE), polypropylene (PP), polyamide (PA), poly(tetrafluoroethylene) (PTFE), poly(vinylidene) fluoride (PVdF), and/or poly(vinyl chloride) (PVC). In one form, the porous separator may comprise a laminate of one or more polymeric materials, such as a laminate of PE and PP.

The negative and positive current collectors 18, 22 respectively associated with the negative electrode material layer 20 and the positive electrode material layer 24 may comprise any material that is capable of collecting and reversibly passing free electrons to and from their respective electrode material layers 20, 24. For example, each of the negative and positive current collectors 18, 22 may comprise an electrically conductive metal or metal alloy, e.g., a transition metal or alloy thereof. In some specific examples, the negative current collector 18 may comprise copper, nickel, an iron alloy (e.g., stainless steel), or titanium, and the positive current collector 22 may comprise aluminum, nickel, or an iron alloy (e.g., stainless steel). Other electrically conductive metals may of course be used, if desired. The negative and positive current collectors 18, 22 each may be in the form of a thin and flexible porous or non-porous metal substrate. For example, the negative and positive current collectors 18, 22 may be in the form thin and flexible non-porous metal foils, porous metal meshes, or perforated metal sheets. The specific configuration of the negative and positive current collectors 18, 22 may depend upon the intended application of the electrochemical cell 10.

The positive electrode material layer 24 may comprise one or more electrochemically active materials that can undergo a reversible redox reaction with lithium at a higher electrochemical potential than the negative electrode material layer 20 such that an electrochemical potential difference exists between the positive electrode material layer 24 and the negative electrode material layer 20. In one form, the positive electrode material layer 24 may comprise an intercalation host material in the form of a metal oxide that can undergo the reversible insertion or intercalation of lithium ions. In such case, the intercalation host material of the positive electrode material layer 24 may comprise a layered oxide represented by the formula LiMeO₂, an olivine-type oxide represented by the formula LiMePO₄, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). For example, the intercalation host material may comprise a layered lithium transition metal oxide, such as lithium cobalt oxide (LiCoO2) and lithium-nickel-manganese-cobalt oxide [Li(NixMnyCoz)O₂], a spinel lithium transition metal oxide, such as spinel lithium manganese oxide (LiMn₂O₄), lithium iron phosphate (LiFePO₄), or lithium fluorophosphate (Li₂FePO₄F), lithium nickel oxide (LiNiO₂), lithium aluminum manganese oxide (LixAl_{Y}Mn_{1-Y}O₂), lithium vanadium oxide (LiV₂O₅), or a combination thereof. In another form, the positive electrode material layer 24 may comprise a conversion material including a component that can undergo a reversible electrochemical reaction with lithium, in which the component undergoes a phase change or a change in crystalline structure accompanied by a change in oxidation state. In such case, the conversion material of the positive electrode material layer 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. Suitable metals for inclusion in the conversion material of the positive electrode material layer 24 include iron, manganese, nickel, copper, and cobalt. The electrochemically active material of the positive electrode material layer 24 may be intermingled with a polymeric binder material to provide the positive electrode material layer 24 with structural integrity. Examples of polymeric binders include polyvinylidene fluoride (PVdF), ethylene propylene diene monomer (EPDM) rubber, styrene butadiene rubber (SBR), carboxymethyl cellulose (CMC), polyacrylic acid, and mixtures thereof. The positive electrode material layer 24 optionally may include particles of an electrically conductive material, which may comprise very fine particles of, for example, high-surface area carbon black.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A composite electrode material comprising:
a carbon-based matrix component; and
a silicon-based particulate component embedded in the carbon-based matrix component,
wherein the silicon-based particulate component includes a plurality of core-shell structures, with each core-shell structure including:
a silicon core,
an intermetallic layer overlying the core, and
a graphitic shell surrounding the silicon core and the intermetallic layer.

2. The composite electrode material of claim 1 wherein the silicon-based particulate component accounts for, by weight, 10% to 90% of the composite electrode material.

3. The composite electrode material of claim 1 wherein the plurality of core-shell structures are homogenously distributed throughout the carbon-based matrix component.

4. The composite electrode material of claim 1 wherein the silicon core comprises, by weight, greater than 99% silicon (Si).

5. The composite electrode material of claim 1 wherein the intermetallic layer comprises a metal silicide, and wherein the metal silicide comprises at least one metal selected from the group consisting of copper, nickel, iron, or cobalt.

6. The composite electrode material of claim 1 wherein, in each core-shell structure, the intermetallic layer is disposed between the silicon core and the graphitic shell.

7. The composite electrode material of claim 1 wherein the graphitic shell comprises crystalline graphite.

8. The composite electrode material of claim 1 wherein the carbon-based matrix component comprises an amorphous hard carbon.

9. The composite electrode material of claim 1 wherein the carbon-based matrix component does not include discrete particles or regions of crystalline graphite.

10. A method of making a composite electrode material, the method comprising:
providing a plurality of silicon particles, with each silicon particle having a surface;
depositing a metal catalyst layer on the surface of each silicon particle to form a plurality of precursor structures;
dispersing the precursor structures in an organic polymeric material to form a precursor electrode material; and
heating the precursor electrode material in an inert environment: (i) to convert the organic polymeric material into a carbon-based material, (ii) to convert at least a portion of the metal catalyst layer on the surface of each silicon particle into a metal silicide, and (iii) to form a graphitic shell around each silicon particle.

11. The method of claim 10 wherein the plurality of silicon particles exhibit a mean particle diameter in a range of 10 nanometers to 40 micrometers.

12. The method of claim 10 wherein the metal catalyst layer is deposited on the surface of each silicon particle using a wet chemical deposition technique, a chemical vapor deposition technique, or a high energy ball milling technique.

13. The method of claim 10 wherein the metal catalyst layer comprises at least one metal selected from the group consisting of copper, nickel, iron, or cobalt.

14. The method of claim 10 wherein the metal catalyst layer has a thickness in a range of 2 nanometers to 200 nanometers.

15. The method of claim 10 wherein the organic polymeric material comprises polyimide or polyacrylonitrile.

16. The method of claim 10 wherein the precursor electrode material is heated in the inert environment at a temperature in a range of 400° C. to 900° C. to pyrolyze the organic polymeric material.

17. The method of claim 10 wherein, during heating of the precursor electrode material in the inert environment, the metal catalyst layer on the surface of each silicon particle promotes formation of the graphitic shell around each silicon particle.

18. The method of claim 10 wherein, during heating of the precursor electrode material in the inert environment, the metal catalyst layer on the surface of each silicon particle physically isolates each silicon particle from the organic polymeric material and prevents formation of silicon carbide (SiC).

19. A method of making a composite negative electrode material for a lithium-ion battery, the method comprising:
providing a plurality of silicon particles, with each silicon particle having a surface;
depositing a metal catalyst layer on the surface of each silicon particle to form a plurality of precursor structures;
dispersing the precursor structures in an organic polymeric material to form a precursor electrode material; and
heating the precursor electrode material in an inert environment to pyrolyze the organic polymeric material and transform the precursor electrode material into a composite electrode material that includes a carbon-based matrix component and a silicon-based particulate component embedded in the carbon-based matrix component,
wherein the silicon-based particulate component includes a plurality of core-shell structures, with each core-shell structure including a silicon core, an intermetallic layer overlying the core, and a graphitic shell surrounding the silicon core and the intermetallic layer.

20. The method of claim 19 wherein the intermetallic layer comprises a metal silicide, and wherein the metal silicide comprises at least one metal selected from the group consisting of copper, nickel, iron, or cobalt.
